(19) United States
(12) Patent Application Publication
(10) Pub. No.: US 2009/0318065 A1
(43) Pub. Date: Dec. 24, 2009

(54) MOTOR-DRIVEN MACHINE TOOL

(76) Inventors: Adolf Zaiser, Koengen (DE); Jens Blum, Filderstadt (DE); Heiko Roehm, Stuttgart (DE)

Correspondence Address: MICHAEL J. STRIKER, 103 EAST NECK ROAD, HUNTINGTON, NY, 11743, US

(21) Appl. No.: 12/376,004

(22) PCT Filed: Feb. 27, 2008
(86) PCT No.: PCT/EP08/52391

§ 371 Date: Feb. 2, 2009

(30) Foreign Application Priority Data
Apr. 9, 2007 (DE) 102007018467.2

(51) Int. Cl. B25F 5/00; B24B 23/00; B23B 31/06

(52) U.S. Cl. 451/344; 279/142

(57) ABSTRACT

The invention relates to a motor-driven machine tool having a rotationally drivable tool, comprising a tool shaft, on the face of which a fastening device is provided for receiving and fastening the tool. The fastening device is detachably received on the tool shaft. An auxiliary tool for loosening the fastening device has a pull-off unit for loosening the mounting device, the unit engaging the fastening device on the tool shaft from behind, and a support part on the pull-off unit, the part supporting the pull-off unit in the operating mode using a supporting and loosening force on the machine tool. A further auxiliary tool for disposing the fastening device on the tool shaft has a clamping part, which is to be firmly connected to the machine tool in the operating mode, and a pressing unit for applying pressure on the fastening device, wherein the pressing unit is disposed on the clamping part in an adjustable manner

The present invention relates to a motor-driven machine tool having a tool shaft which is driven by a drive unit, for receiving a tool according to the preamble of claim 1.

### BACKGROUND INFORMATION

DE 10 2004 050 798 A1 discloses a hand-held power tool which includes an electric motor-driven tool on a tool shaft which performs an oscillating, rotational pendulum motion, thereby making it possible to use the hand-held power tool for grinding and cutting. The tool is attached via a fastening device to the end face of the tool shaft, the fastening device including a locating flange on the tool shaft which includes, in a plane which is perpendicular to the rotational axis, axially projecting form-fit elements distributed around the circumference, and on which a fastening section of the tool may be inserted using recesses having a corresponding design. After the tool has been inserted onto the form-fit elements of the locating flange, the tool is secured using a fastening screw.

In the case of fastening devices of this type, an effective form-fit connection must be ensured for long operating periods. If the form-fit connection becomes worn, the tool shaft must be replaced, which requires a great deal of effort.

### DISCLOSURE OF THE INVENTION

The object of the present invention is to make it easier to replace the fastening device on a machine tool, the fastening device being used to attach the tool.

This object is achieved according to the present invention having the features of claim 1. The dependent claims describe expedient developments.

The motor-driven machine tool, which is a hand-held power tool in particular having a rotatably driveable tool, includes a tool shaft which is driven by a drive unit—usually an electric motor—a fastening device being provided on the end face of the tool shaft for receiving and fastening the tool. According to the present invention, the fastening device is detachably accommodated on the tool shaft. This design makes it possible to remove only the fastening device from the tool shaft and to replace it if wear should occur, without the need to also remove and reinstall the tool shaft itself. The tool shaft may remain in the tool, and it is only necessary to remove and replace the fastening device from the tool shaft, thereby greatly reducing the maintenance effort and material outlay required.

According to an expedient embodiment, the fastening device is the end-face extension of the tool shaft. In this embodiment, the fastening device is not slid onto the shaft, but is merely placed on the end face of the shaft, thereby providing the advantage that a machine tool which is compact in the axial direction may be realized. It is also possible to easily attach the fastening device on the end face of the shaft, given that, e.g. the fastening device includes an annular shoulder which is placed on a corresponding projection on the tool shaft. The connection between the fastening device and the tool shaft is established, e.g. via frictional engagement. Other types of connections are also possible, in particular a form-fit connection that acts in the axial direction and is realized, e.g. using a bayonet connection, or a connection using other types of connection devices, e.g. clamping devices or like. Basically, it is possible to use frictional, form-fit, or bonded connections, or any combinations thereof. When there is an annular shoulder on the fastening element and an associated projection on the tool shaft, a frictional connection is advantageously established by designing the fastening device to be annular in shape, so that it may be slid onto the projection on the tool shaft, forming an interference fit.

Advantageously, the fastening device is annular in design, and a threaded bore is provided in the end face of the tool shaft, which is reached from the outside via the circular recess in the fastening device, thereby making it possible to screw an additional component into the threaded bore even when the fastening device is in place. This additional component may be, e.g. a further component of the fastening device, which is used to securely lock the tool on the tool shaft.

It is also possible to screw in a component of an auxiliary device which is used to release or install the fastening part which is connected to the tool shaft via frictional engagement in particular. The auxiliary tool used to release the fastening device is expediently composed of a removal device which reaches behind the fastening device on the tool shaft, and a support part on the removal device which, in the working position, supports the removal device on the machine tool using a support and release force. The support part is expediently designed as a threaded rod which is rotatably guided into a thread in the removal device, and which may be screwed into the threaded bore in the end face of the tool shaft. To remove the fastening device from the tool shaft, the removal device of the auxiliary tool is placed on the fastening device in a manner such that the removal devices reaches behind the fastening device, thereby resulting in a form-fit connection in the axial direction. Finally, the support part which is designed as a threaded rod is screwed into the threaded recess in the end face of the tool shaft, and the removal device may then be rotated—as the threaded rod remains still—in the release direction. Due to the form-fit connection, the fastening device is released axially from the seat on the tool shaft.

The threaded rod may also be a component of a further auxiliary tool which is used to attach the fastening device to the tool shaft. For this purpose, the threaded rod performs the function of a clamping part which interacts with a pressing device to act on the fastening device in the fastening position. This pressing device is advantageously designed as a nut which is situated on the outer thread of the threaded rod. After the threaded rod has been screwed into the threaded recess in the end face of the tool shaft, the annular fastening device—which has been slid onto the threaded rod—may be pressed axially into the fastening seat on the end face of the tool shaft by rotating the nut.

Further advantages and expedient embodiments are depicted in the further claims, the description of the figures, and the drawings.

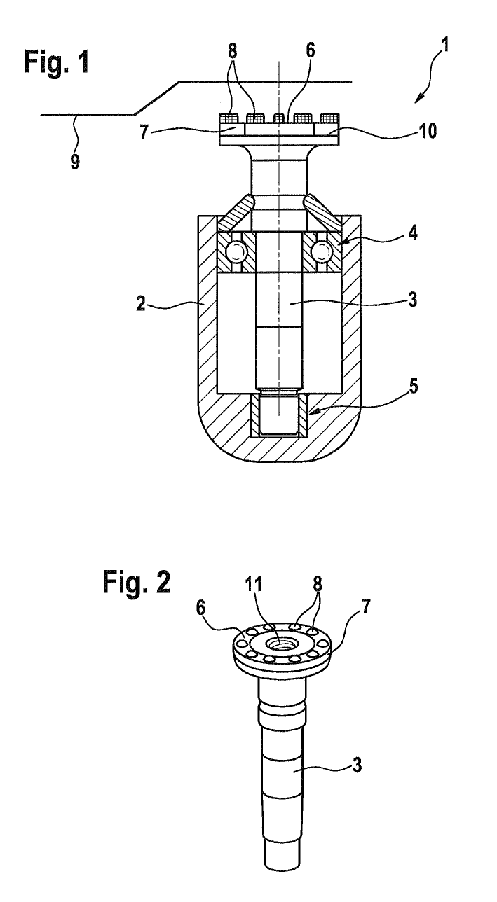

FIG. 1 shows a schematic depiction of a hand-held power tool having a drive shaft which is also used as the tool shaft, on the end face of which a fastening device is situated for receiving and holding a tool,

FIG. 2 shows a perspective view of the tool shaft with the fastening device installed on the end face,

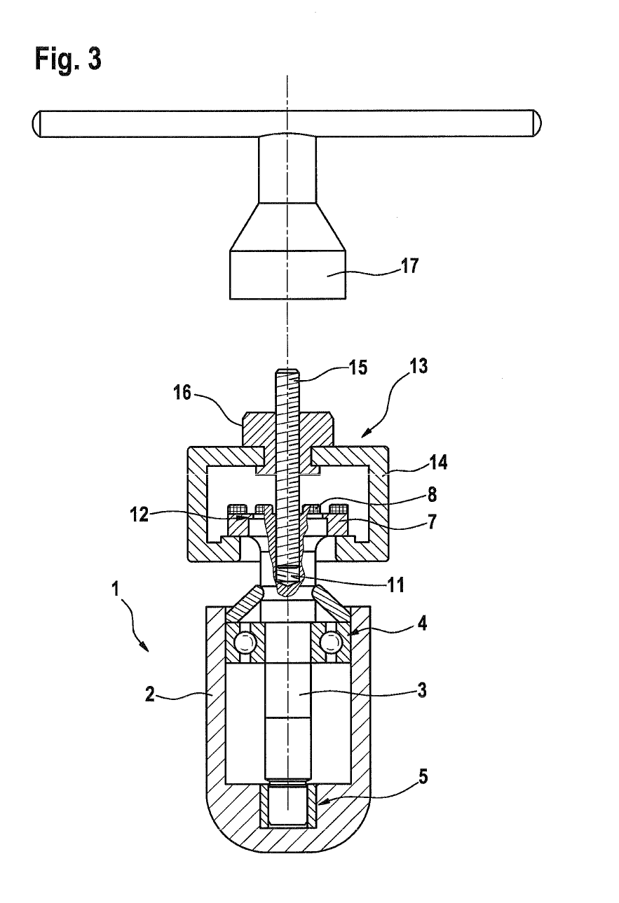

FIG. 3 shows the hand-held power tool having an interacting auxiliary tool for removing the fastening device from the tool shaft in the axial direction,

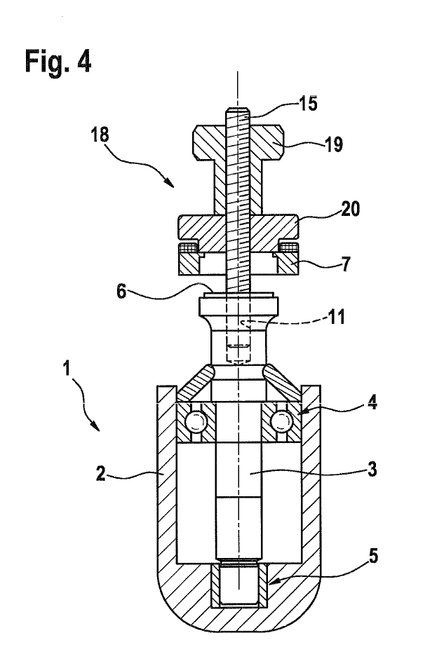

FIG. 4 shows the hand-held power tool which includes a further auxiliary tool which is used to situate the fastening device on the end face of the tool shaft.

Components that are the same are labelled with the same reference numerals in the figures.

Hand-held power tool 1 shown in FIG. 1 is, in particular, a cutting and grinding device, the tool of which may perform an oscillating, rotational pendulum motion about the rotational axis of the tool shaft. Hand-held power tool 1 includes, in a housing 2, an electric motor-driven tool shaft 3 which is rotatably accommodated in housing 2 via bearing points 4 and 5. A fastening ring 7 is placed on tool shaft 3 via frictional engagement on the free end face 6 which extends out of housing 2. A form-fit connection is also possible, in addition or as an alternative thereto, which may be designed, e.g. as a type of bayonet connection. On the free end face, fastening ring 7 includes axially projecting nubs 8 which project axially and are distributed evenly around the circumference, to which recesses in a fastening plate of tool 9 are assigned. To fasten tool 9 on tool shaft 3 and lock it in place, the fastening plate with the recesses is pressed onto nubs 8 of the fastening ring.

Drive and/or tool shaft 2 and fastening ring 7 are separate components which are to be connected, it being possible to remove the fastening ring from tool shaft 3 if necessary.

A projection 10 designed as an annular shoulder is formed on the end face of tool shaft 3. Projection 10 is matched to fastening ring 7 in terms of shape and size, and it may be pressed onto the fastening ring with frictional engagement. The frictional connection is selected such that a sufficiently great frictional force exists between the fastening ring and the end face of the tool shaft, which reliably prevents the fastening ring from becoming accidentally detached from the tool shaft during operation.

FIG. 2 shows tool shaft 2 with the fastening ring installed, in a perspective, isolated view. A threaded bore 3 which may be reached from the outside in the axial direction via the circular recess in fastening ring 7 is formed in the end face of tool shaft 3.

FIG. 3 shows hand-held power tool 1 with an auxiliary tool 13 for removing fastening ring 7 from tool shaft 3. Auxiliary tool 13 includes a frame-shaped removal device 14 which, in the working position, reaches behind fastening ring 7 which has been placed on the end face of tool shaft 3. A threaded rod 15 is also assigned to auxiliary tool 13, which is used as a support part and is guided into and extends through a threaded bore in the removal device. In the working position, threaded rod 15 is screwed into end-face threaded bore 11 in tool shaft 3. The threaded bore in removal device 14 extends through a polygon 16 which performs the function of a force-application part and is fixedly situated on frame-shaped removal device 14.

After the end face of threaded rod 15 has been screwed into threaded bore 11 in tool shaft 3, a socket wrench with an internal polygonal shape is rotated on polygon 16 situated on removal device 14, thereby also rotating removal device 14 about the rotational axis of threaded rod 15. Given that removal device 14 reaches behind fastening ring 7, fastening ring 7 is released axially from its seat on the end face of tool shaft 3.

FIG. 3 shows fastening ring 7 which has an alternative cross-sectional shape to that of the embodiment shown in FIG. 2. Fastening ring 7 includes an upper annular shoulder 12 which extends radially inwardly, and which is seated on an associated, end-face projection on tool shaft 3.

FIG. 4 shows hand-held power tool 1 with a further auxiliary tool 18 which is used to locate and slide fastening ring 7 onto end face 6 of tool shaft 3. Second auxiliary tool 18 includes threaded rod 15 which performs the function of a clamping part, with the aid of which fastening ring 7 is guided and clamped in order to be slid into place. Second auxiliary tool 18 also includes a nut 19 which is used as a pressing device and a securing device, via which fastening ring 7 is pressed into its end-face position on tool shaft 3.

To attach ring 7 on tool shaft 3, the fastening ring is placed on threaded rod 15, then threaded rod 15 is screwed into threaded bore 11 in the end face of the tool shaft. Fastening ring 7 is held captive axially via nut 19, and it is acted upon in the axial direction via force from a thrust washer 20 which rests loosely on threaded rod 15 in the axial direction.

Once threaded rod 15 has been screwed into threaded bore 11 in tool shaft 3, nut 19 may be rotated on the outer thread of threaded rod 15 using socket wrench 17 shown in FIG. 3, thereby sliding fastening ring 7—via thrust washer 20—axially into its working position on the end face of tool shaft 3.

What is claimed is:

1. A motor-driven machine tool, in particular a hand-held power tool (1), comprising a rotatably drivable tool (9) having a driveable tool shaft (3), on the end face (6) of which a fastening device (7) which is used to receive and fasten the tool (9) is located,
wherein
the fastening device (7) is detachably accommodated on the tool shaft (3).

2. The machine tool as recited in claim 1,
wherein
the fastening device (7) which is placed on the tool shaft (3) is installed on the end face (6) of the tool shaft (3).

3. The machine tool as recited in claim 1,
wherein
the fastening device (7) includes a form-fit part (8) for accommodating the tool (9) in a form-fit manner.

4. The machine tool as recited in claim 1,
wherein
the fastening device (7) is held on the tool shaft (3) via frictional engagement.

5. The machine tool as recited in claim 1,
wherein
the fastening device (7) is held on the tool shaft (3) via a form-fit connection.

6. The machine tool as recited in claim 1,
wherein
the fastening device (7) includes an annular shoulder (12) which may be placed on a corresponding projection of the tool shaft (3).

7. The machine tool as recited in claim 1,
wherein
the fastening device (7) is annular in design.

8. The machine tool as recited in claim 7,
wherein
a threaded bore (11) is formed in the end face (6) of the tool shaft (3).

9. An auxiliary tool (13) for removing the fastening device (7) from the tool shaft (3) in a machine tool (1) as recited in claim 1, characterized by a removal device (14) for reaching behind the fastening device (7), and by a support part (15) on the removal device (14) which, in the working position, supports the removal device (14) on the machine tool (1) using a support and release force.

10. The auxiliary tool as recited in claim 9,
wherein
the support part is a threaded rod (15) which extends into a thread in the removal device (14) and through the removal device.

11. The auxiliary tool as recited in claim 9,
wherein
a force-application part (16) which is situated coaxially to the rotational axis of the support part (15) is located on the removal device (14), via which the removal device (14) may be rotated about the rotational axis.

12. The auxiliary tool (18) for situating the fastening device on the tool shaft in a machine tool as recited in claim 1, characterized by a clamping part (15) which, in the working position, is to be fixedly connected to the machine tool (1), and by a pressing device (19) for applying pressure to the fastening device (7), the pressing device (19) being situated on the clamping part (15) in an adjustable manner.

13. The auxiliary tool as recited in claim 12,
wherein
the clamping part is a threaded rod (15) which extends into a thread in the pressing device (19).

14. The auxiliary tool as recited in claim 13,
wherein
the pressing device (19) is rotatable about the rotational axis of the clamping part (15).

15. The auxiliary tool as recited in claim 14,
wherein
the pressing device is designed as a nut (19).
